(19) United States
(12) Patent Application Publication
(10) Pub. No.: US 2013/0342493 A1
(43) Pub. Date: Dec. 26, 2013

(54) Touch Detection on a Compound Curve Surface

(71) Applicants: William M. Crow, Sequim, WA (US); Harshavardhana Narayana Kikkeri, Bellevue, WA (US); Glen C. Larsen, Issaquah, WA (US)

(72) Inventors: William M. Crow, Sequim, WA (US); Harshavardhana Narayana Kikkeri, Bellevue, WA (US); Glen C. Larsen, Issaquah, WA (US)

(73) Assignee: MICROSOFT CORPORATION, Redmond, WA (US)

(21) Appl. No.: 13/528,128

(22) Filed: Jun. 20, 2012

(51) Int. Cl. G06F 3/042; G06F 3/044; G06F 3/041

(52) U.S. Cl. 345/174; 345/173; 345/175

(57) ABSTRACT

Described is detecting touch on a compound curve surface that displays content for touch-based interaction. Touch may be detected by processing an infrared image to detect a shadow corresponding to the touch, and/or by detecting infrared reflection corresponding to the touch. Also described is providing a curved surface with capacitive sensing. Also described is the use of frustrated total internal reflection to detect touch.

### BACKGROUND

Conventional touch detection technologies are designed to work with flat display screens. While flat display screens are useful in many scenarios, mainstream projection technology makes projection onto compound curve screens possible for products in the consumer price range, enabling products which utilize displays on surfaces with compound curvature.

However, some touch screen technologies have heretofore only been able work with a flat surface. For example, transparent capacitive touch screen technology based upon Indium Tin Oxide (ITO) solutions cannot be used with a compound curve screen because of the fragility of ITO.

For example, projecting light from the sides does not work with a curved screen. Additionally, in cases where the screen needs to be thin and light, projecting IR light from the sides is also impractical. Attempts to use infrared (IR) illumination to sense touch have been unsuccessful, as interference from ambient IR light (such as sunlight) masks the projected IR light.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which touch is able to be detected on a compound curve surface. In one aspect, content is projected so as to be visible through a compound curved surface. Upon detecting a touch on the compound curve surface data corresponding to screen coordinates that represent a location of the touch is output. In one aspect, detecting the touch comprises processing an infrared image to detect a shadow corresponding to the touch. In one aspect, detecting the touch comprises processing an infrared image to detect a reflection corresponding to the touch.

In one aspect, a curved surface with capacitive sensing is provided, including combining capacitive sensing material with a diffusing substrate, and bonding the combined capacitive sensing material and diffusing substrate to a transparent interaction surface.

In one aspect, light is transmitted vertically and horizontally through a compound curve surface in various rows and columns that provide total internal reflection when not touched. Touching the surface causes frustrated total internal reflection, which is sensed to determine where the touch is occurring.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is an example representation of a user interacting via touch with a compound curve surface that displays projected content, and components for detecting the touch according to one example embodiment.

FIG. 2 is an example representation of an infrared image from an infrared camera in which the image include a shadow corresponding to a touch point according to one example embodiment.

FIG. 3 is an example representation of how an image may be divided into grids to detect possible touch points thereon, according to one example embodiment.

FIG. 4 is a flow diagram representing example steps that may be taken by a detection algorithm to find any touch points by processing an image to look for shadows, according to one example embodiment.

FIG. 5 is an example representation of capacitive sensing material bonded to a curve surface, according to one example embodiment.

FIG. 6 is an example representation of sensing touch by detecting infrared reflections according to one example embodiment.

FIGS. 7A and 7B are example representations of sensing touch by detecting frustrated total internal reflection according to one example embodiment.

FIG. 8 is a block diagram representing an example computing environment into which aspects of the subject matter described herein may be incorporated.

### DETAILED DESCRIPTION

Various aspects of the technology described herein are generally directed towards detecting human touch interaction on a compound curve screen, such as a rear projection screen. In one aspect, an infrared (IR)-sensitive camera mounted behind the screen is oriented with a field of view that matches the desired touch region. IR light is projected outward from the outside of the screen and reflects off any nearby objects, which typically is the person standing in front of and interacting with the touch screen. The IR camera behind the screen detects this IR ambient light, which is diffused by the surface of the projection screen. When any object comes in contact with the screen, the object creates a shadow with distinct high contrast edges. The technology described herein detects such a high contrast shadow as an indication that the screen is being touched. Because the technology is based upon detecting shadows in ambient IR light, there is no interference from additional IR illumination, and indeed, additional IR illumination can increase the contrast.

In another aspect, capacitive touchscreen material is joined to a target compound curve surface. The material is bonded to the surface in a manner that does not interfere with the quality of the projected visual image.

In another aspect, IR reflection may be sensed. This includes positioning one or more IR sources to illuminate a finger that contacts the screen.

In another aspect, a screen having materials that provide total internal reflection is provided. When touched, the reflective properties are changed, and such frustrated total internal reflection is sensed to determine where the touch is occurring.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in touch detection in general.

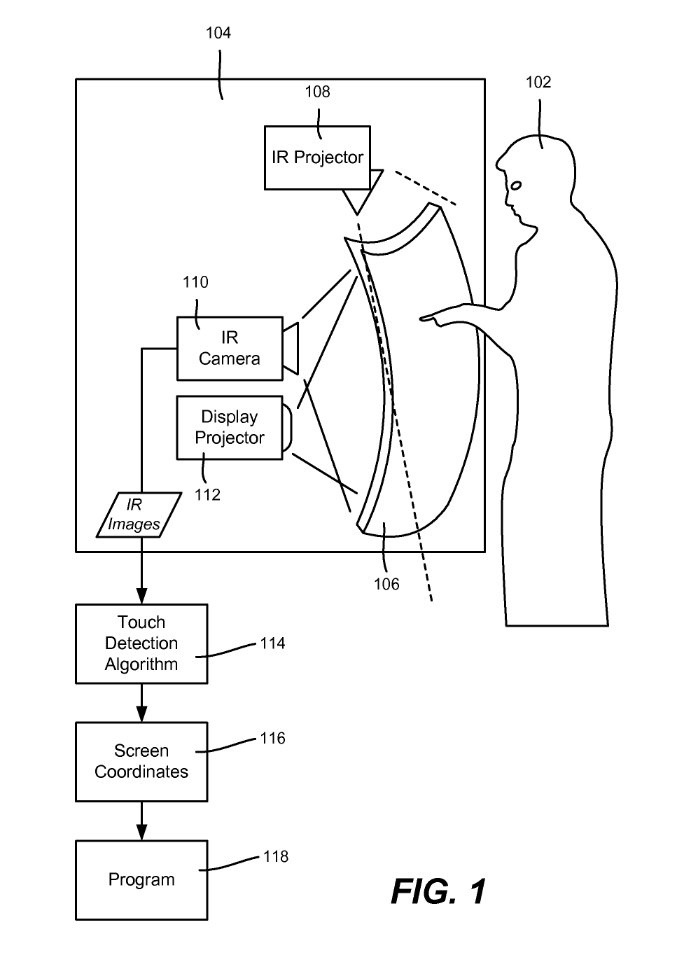

FIG. 1 is a representation of one example embodiment showing a user 102 interacting with a device 104 comprising a display screen 106 having a compound curve surface. As will be understood, in this example embodiment, optical detection is used, whereby no changes need to be made to the screen.

In FIG. 1, an IR projector 108 emits infrared light which is reflected back towards the screen and sensed by an IR sensor/camera 110 that is aimed to capture images through the diffused surface of the screen 106. In general, the camera 110 is positioned to have an unobstructed view of the screen area that is illuminated by a display projector 112.

When engaging via touch, the user 102 is typically standing or sitting directly in front of the device 104, providing the IR reflection. Notwithstanding, reflections from walls or the like also typically provide sufficient reflection, e.g., even when a user is standing to the side of the screen. In general, any ambient room light is combined with reflected IR from the projected light source or sources, and provides sufficient illumination in a wide range of lighting conditions to accurately detect touch point shadows as described herein.

In one implementation, a Microsoft® Kinect™ device is used as the source of the projected IR ambient light. By pointing the device head assembly relatively straight ahead and level (or tracking the user if possible at the close range), the IR illumination from the Kinect™ projector, reflected off the user, provides a sufficient IR source to backlight the screen and provide the needed shadow contrast. In other implementations, one or more other IR light sources may be used.

The display projector 112 projects frames onto the screen, and in general is as close to the IR camera 110 as possible to facilitate alignment of the displayed output with the sensed interaction locations so as to reduce parallax distortion; note that one or more mirrors may be used to get the alignment closer than can be done with physical devices. Notwithstanding, mathematical techniques may be used to further improve the effective alignment.

In general, because of the reflected IR being sensed by the camera 110, if any object is in contact with the screen 106, the object creates a distinct shadow, with much higher contrast edges between the illuminated portions and the shadowed portions of the screen 106. This high contrast difference can be used to detect the contact points. The size of the area that represents this high threshold illumination difference to the surrounding area is dependent on the size of the object touching the screen. This can be used to look for and detect objects that cover the range of sizes typical for human fingers, for example.

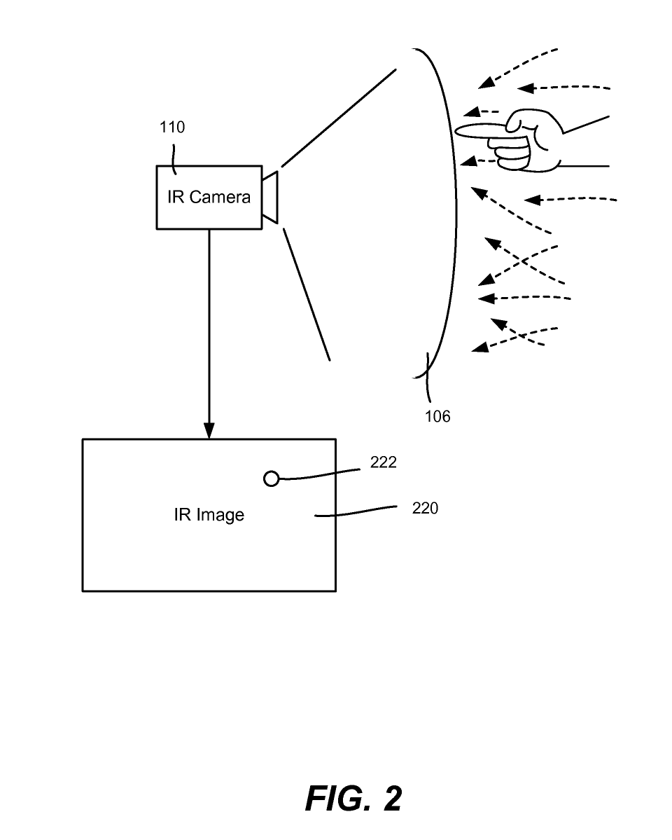

Thus, as represented in FIG. 2, a finger touch on the screen creates an image 220 having a detectable shadow pattern 222, as (most of) the reflected IR light (represented in FIG. 2 by the dashed wavy arrows) is blocked at that location. The image is processed by an algorithm 114 (FIG. 1) that detects the finger pattern 222. Note that the image resolution may be adjusted, such as to provide less data to process for finger detection, or more data so as to work with other pointing devices such as a stylus.

An example of one suitable detection algorithm 114 is exemplified herein. As will be understood, the example detection algorithm 114 accommodates various issues. For one, the example detection algorithm that looks for this pattern needs to be relatively agnostic to the orientation of the finger. That same algorithm may use the pattern of finger touch to further return information about the orientation of the finger relative to the screen.

Further, with a typical IR reflected image from what may be arbitrary sources of direct or reflected ambient IR light, because of the luminance variation (somewhat gradient-like) across the entire image, no single threshold value with respect to luminance differences work for all conditions or all areas on the screen. Shadows from the hand and/or fingers that are not touching the screen also change the luminance at their corresponding locations.

The amount of IR light thus varies across the surface of the curved screen, and indeed, the contrast of an object touching the screen is often less than the contrast variation of the ambient light across the entire screen. For example, with a single, IR light source positioned at the top of the device, the luminance is generally brighter near the top of the image and gets dimmer nearer the bottom.

Therefore, it is generally not possible to detect touch by simply looking for areas in the IR image that fall below a certain threshold value. Instead, in one embodiment, the algorithm 114 looks for local contrast differences, delineated by sharp contrast edges between adjacent local areas with an illumination difference exceeding a target threshold. The specific target threshold also varies relative to the local illumination, that is, the threshold value at any point may be determined by a function of a luminance value nearby that point.

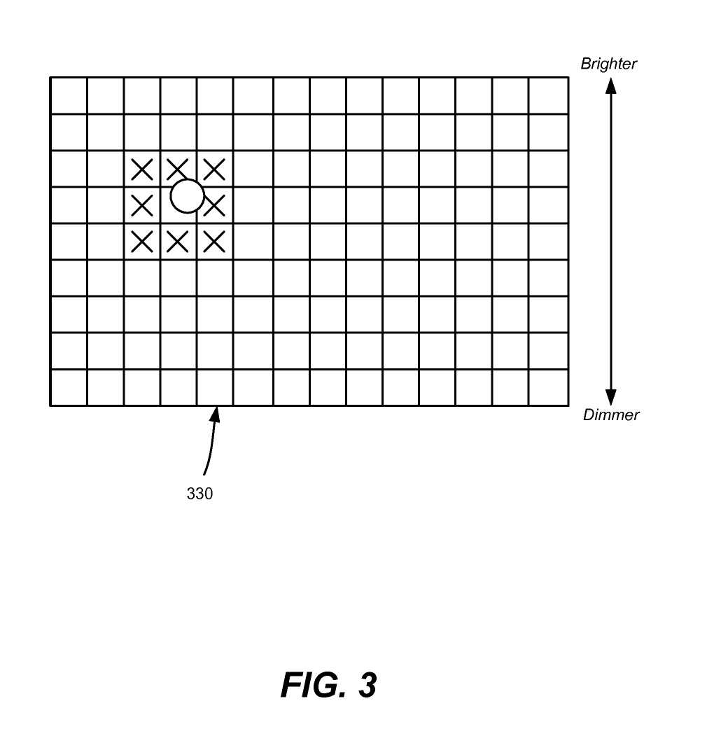

The algorithm is able to detect a single touch, or an arbitrary number of multiple touch events (by not stopping after the first detection), at a resolution appropriate for touch interactions. To this end, as generally represented in FIG. 3, in one implementation the image 330 to be processed is algorithmically divided into a grid of equally-sized squares, with square corresponding to the size of a typical finger (e.g., with the number of pixels depending on the screen size and resolution, e.g., five-by-five or six-by-six pixels in one implementation). Note that the number of grids in FIG. 3 is not intended to be representative of any actual implementation; for example, one implementation used a grid array of 24-by-15 blocks. The image may be cropped to use only the portions that correspond with the frame of the rear projection screen image. Various techniques (e.g., using red and green channels, or converting to monochrome) may be used to obtain an image with good contrast.

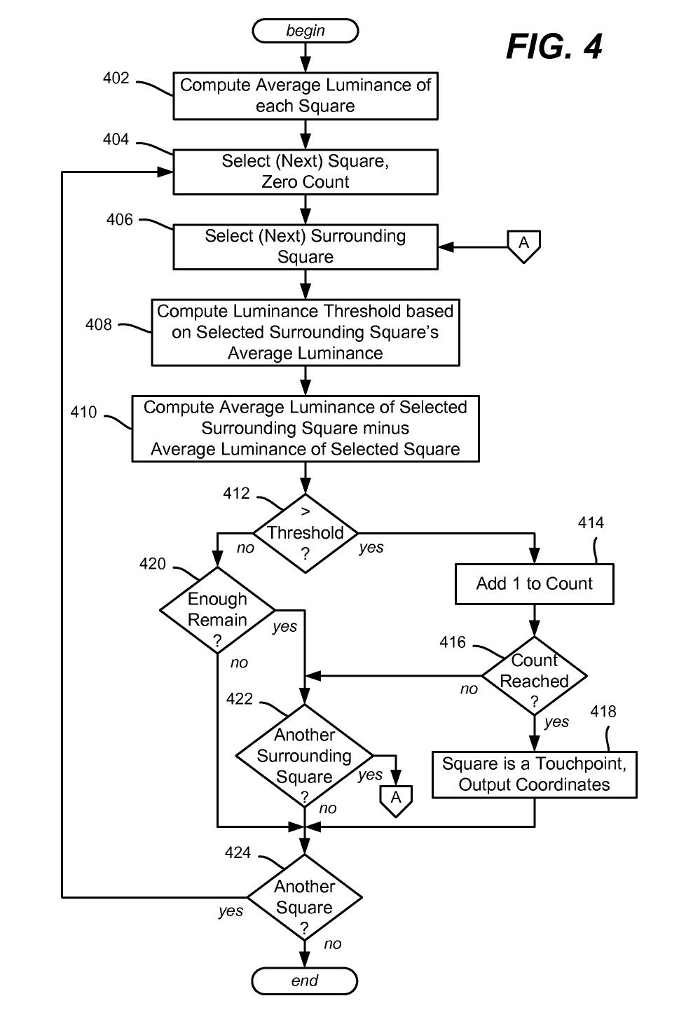

In the example algorithm, generally exemplified in FIG. 4, the average illumination of each square is computed (step 402). For non-edge squares, each square is selected (step 404) as an evaluation area and compared with a selected one (step 406) of the adjacent eight squares that surround the selected square to determine if the selected square is darker (step 410) than the selected surrounding square by a threshold amount that is relative (step 408) to the illumination level of the surrounding square; (edge squares may use a similar technique). A suitable threshold delta value is one-fourth the luminance value of the surrounding block being compared. An alternative is to use N (e.g., ten) evenly separated deltas between the upper threshold used to detect “bright” blocks and the lower threshold used to detect “dark” blocks.

The comparison may be repeated (step 422) for up to all eight surrounding squares. If (steps 414 and 416) the selected square is darker by at least the threshold value than at least some number (e.g., five) of the surrounding squares, the selected square is determined to be a touch point (step 418). Note that using five surrounding squares compensates for touches that span multiple squares. Further, note that the comparison iterations may end as soon as the number of sufficiently contrasted surrounding blocks is reached, or when not enough surrounding blocks remain to reach the number (step 420). The process may be repeated for each square (step 424). The specific set of surrounding squares that correspond to the threshold difference also may be used determine the orientation of the touch.

The example algorithm has a relatively very small computation time, and is thus able to process each square with a high frequency scanning rate to scan multiple frames per second (e.g., all or a subset of sampled frames) with little impact on overall system performance. Additional enhancements to the algorithm may be made to allow for iterating through different square sizes, provide sophisticated edge detection, and use shape-based detection to detect other types of interactions beyond finger touches. Optimizations may include recognizing that a square is overall too bright (even though brightness is generally locally relative) to be a touch and skipping over such a square with respect to evaluating its surrounding squares. As another optimization, the algorithm may work with a program that outputs the interactive content so as to only evaluate areas of interest as specified by the program.

Any touch point or points detected by the algorithm may be transformed in a piecewise linear manner from the curved surface space to the screen space. For example, the curved surface may be mathematically divided into multiple strips, with a linear transformation using shift and scaling used to transform the coordinates, along with inversion of the X-axis to flip the reverse image. The transformation thus provides for the touch point to screen point conversion.

The algorithm may thus output screen coordinates 114 (FIG. 1) of the touch point or points, which may be used by a program 116 to trigger firing of a control (e.g., a keyboard, list selection, slider control or the like) whose screen position intersects with the touch screen position. A wait timer may be used to reduce false positives by requiring the touch to persist for a given period of time before triggering the control. Shorter wait times make the control more responsive, while longer wait times allow the user to correct any errors. Feedback can be given to the user in various ways, e.g., by highlighting the control currently selected and by showing a circle that animates to completion. When the animation completes, the control is fired.

Turning to another aspect, described herein are various ways to manufacture capacitive touchscreen material, including joining material to a target compound curve surface, and bonding it to that surface in a manner that does not interfere with the quality of the projected visual image. In general, a typical capacitive touchscreen for a display is made of several layers, one layer containing electrical conductors in rows to generate an electrical capacitance, and another layer containing columns to detect interaction with that capacitance. For a display, these conductors or traces and layers need to be transparent, because the touch matrix is overlaid on the display screen. Note that flat capacitive touchscreens are typically made with ITO (Indium Tin Oxide) traces, however as described herein, conductors made with more ductile materials such as carbon nanotubes, nanowires, or PEDOT technologies are more applicable to curved touchscreens.

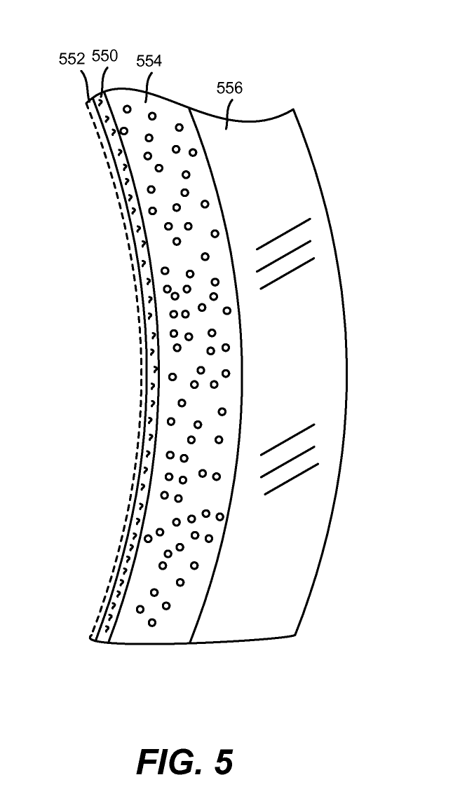

As generally represented in FIG. 5, capacitive sensing may be achieved on curve touchscreen by bonding capacitive sensing material 550 (protected on one side by a thin film 552) to a substrate 554 that provides diffusion properties for the display. A general concept is that the capacitive sensing material 550 can be considered part of the diffusing substrate. The substrate 554 is bonded to a three-dimensional transparent plastic or glass interaction surface 556.

One capacitive sensing approach laminates flat, transparent touchscreen material to flat film, and laminates the flat touchscreen/film onto a flat plastic (or glass) touch interaction surface. The combined laminate is formed into a three-dimensional shape, (e.g., by vacuum forming, air or water pressure forming, or the like). Note that while this approach is relatively straightforward, it limited to simple parts, because the laminate is a flat sheet and complex design and mounting features are not possible.

An alternative capacitive sensing approach is to laminate flat, transparent touchscreen material to flat film and form the touchscreen/film into a three-dimensional shape, (e.g., by vacuum forming, air or water pressure forming, or the like). A three-dimensional plastic touch interaction surface is created (e.g., by injection molding, vacuum forming, or the like), with the combined touchscreen/film bonded to the touch interaction surface optically transparent adhesive. This approach allows more complex geometries, however bonding the three-dimensional film to the three-dimensional plastic interaction surface needs to be carefully performed to avoid air bubbles and optical artifacts. A following molded form is helpful in squeezing bubbles out during joining.

Another alternative capacitive sensing approach is to laminate flat, transparent touchscreen material to flat film and form the touchscreen/film into a three-dimensional shape, (e.g., by vacuum forming, air or water pressure forming, or the like). The three-dimensional touchscreen/film is inserted into an injection mold, with plastic injected against the touchscreen/film using a film insert molding process. This approach benefits from injection pressure, venting, and the thermal interaction of similar materials to ensure bonding with no trapped air.

Yet another alternative capacitive sensing approach is to laminate flat, transparent touchscreen material to flat film, and insert the flat touchscreen/film into an injection mold. Plastic is injected against the touchscreen/film using a film insert molding process, forming the touchscreen/film into a three-dimensional shape simultaneously. This approach is streamlines the number of manufacturing processes, but the injection molding process is more complex, because the film is being formed as well as bonded.

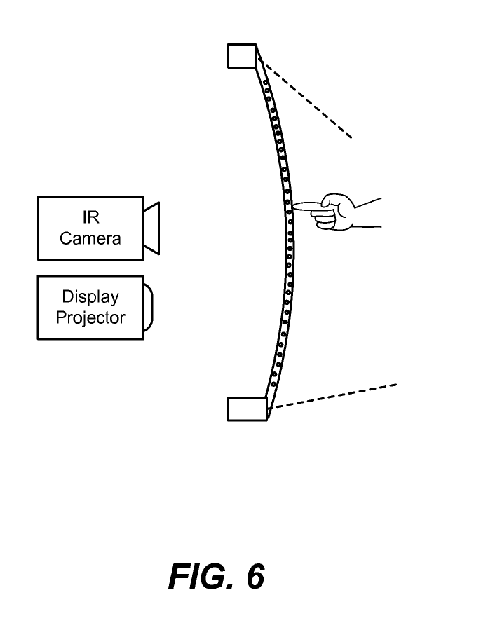

FIG. 6 is an example of an implementation in which reflected IR light is detected to determine touch. In FIG. 6, the IR light sources are behind the screen, however they project through IR transparent areas. Note that surfaces exist that diffuse visible light while being IR transparent. The IR camera senses reflected IR light (rather than IR shadows) off of the finger to determine touch points.

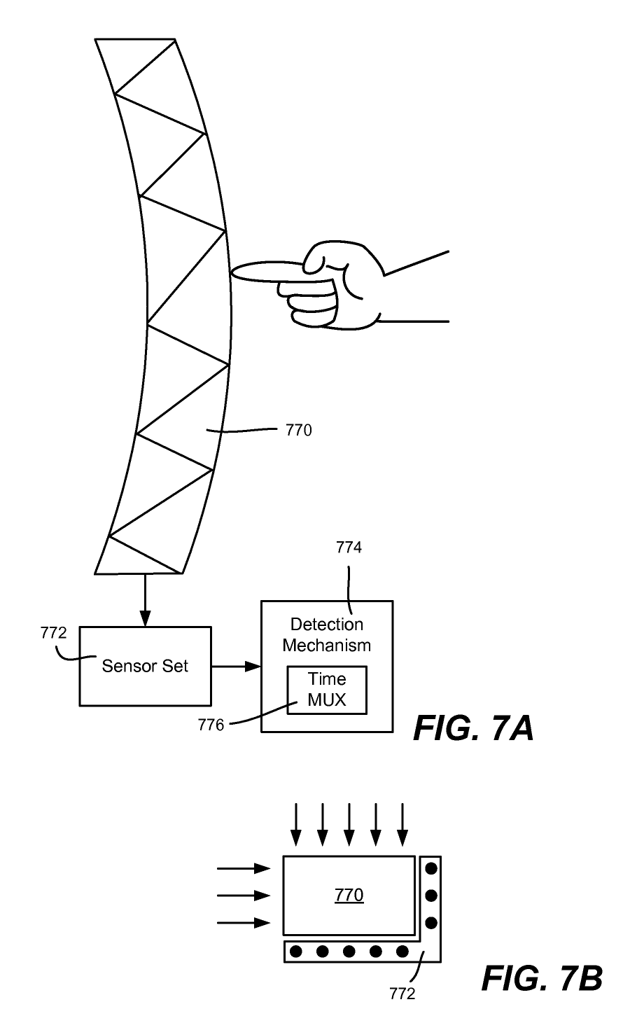

FIGS. 7A and 7B are directed towards another sensing technique, in which rows and columns of light (represented in FIG. 7B by the arrows) is horizontally and vertically transmitted (e.g., via light pipe technology) through a surface 770 configured with material that provides total internal reflection, to reach a corresponding horizontally and vertically arranged set of optical sensors 772. Finger contact with the material changes the optical index of the surface 770, and thereby allows some light to escape. The amount of light sensed by the optical sensors 772 changes for the corresponding row and column being touched, by which a detection mechanism 774 determines where the touch point is based on the intersection of which sensors of the set are changed. Note that for multiple touch detection, time multiplexing of the light may be used with the detection mechanism (block 776), to handle a situation in which multiple touches may be occurring in the same sensor row/column, because in general a sensor only indicates whether a touch is occurring or not for its entire row/column.

### Example Operating Environment

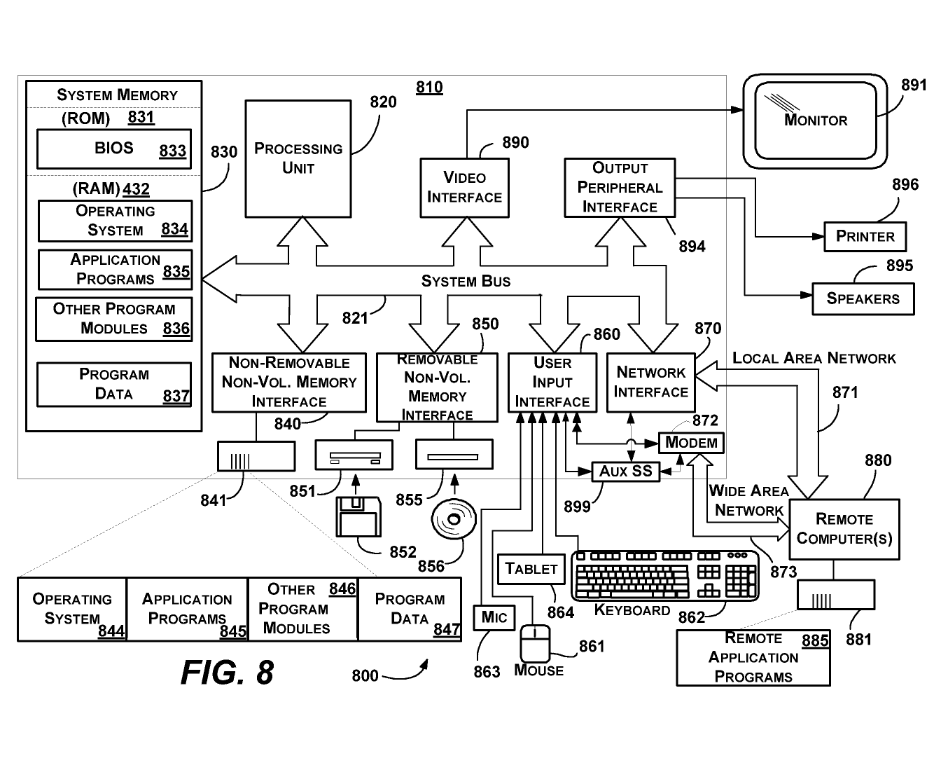

FIG. 8 illustrates an example of a suitable computing and networking environment 800 into which computer-related examples and implementations described herein may be implemented, for example. The computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the example operating environment 800.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 8, an example system for implementing various aspects of the invention may include a general purpose computing device in the form of a computer 810. Components of the computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media can be any available media that can be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 810. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 844, application programs 845, other program modules 846 and program data 847. Note that these components can either be the same as or different from operating system 834, application programs 835, other program modules 836, and program data 837. Operating system 844, application programs 845, other program modules 846, and program data 847 are given different numbers herein to illustrate that, at a minimum, they are different copies. A user may enter commands and information into the computer 810 through input devices such as a tablet, or electronic digitizer, 864, a microphone 863, a keyboard 862 and pointing device 861, commonly referred to as mouse, trackball or touch pad. Other input devices not shown in FIG. 8 may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. The monitor 891 may also be integrated with a touch-screen panel or the like. Note that the monitor and/or touch screen panel can be physically coupled to a housing in which the computing device 810 is incorporated, such as in a tablet-type personal computer. In addition, computers such as the computing device 810 may also include other peripheral output devices such as speakers 895 and printer 896, which may be connected through an output peripheral interface 894 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 871 and one or more wide area networks (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860 or other appropriate mechanism. A wireless networking component 874 such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are examples and other means of establishing a communications link between the computers may be used.

An auxiliary subsystem 899 (e.g., for auxiliary display of content) may be connected via the user interface 860 to allow data such as program content, system status and event notifications to be provided to the user, even if the main portions of the computer system are in a low power state. The auxiliary subsystem 899 may be connected to the modem 872 and/or network interface 870 to allow communication between these systems while the main processing unit 820 is in a low power state.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System on chip systems (SOCs), Complex Programmable Logic Devices (CPLDs), etc.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising:
projecting content to be visible through a compound curved surface;
detecting a touch on the compound curve surface; and
outputting data corresponding to screen coordinates that represent a location of the touch.

2. The method of claim 1 further comprising, detecting multiple touches occurring in conjunction with one another, including detecting at least one other touch.

3. The method of claim 1 wherein detecting the touch comprises processing an infrared image to detect a shadow corresponding to the touch.

4. The method of claim 3 wherein processing the infrared image comprises evaluating luminance-based differences between an evaluation area and a plurality of areas adjacent the evaluation area.

5. The method of claim 4 further comprising, for each of the plurality of areas, computing a threshold value for evaluating each difference, in which each threshold value is computed based upon a representative luminance value of that adjacent area.

6. The method of claim 1 further comprising, performing one or more mathematical computations to transform a touch location on the compound curve surface to the data representing the screen coordinates.

7. The method of claim 1 wherein detecting the touch comprises using capacitive sensing, including bonding touchscreen material to the compound curve surface.

8. The method of claim 1 wherein detecting the touch comprises projecting infrared light in an area where finger interaction is to occur, and sensing infrared reflection off of a finger.

9. The method of claim 1 further comprising transmitting light through a material of the compound curve surface that provides total internal reflection and sensing the transmitted light, and wherein detecting the touch comprises optically sensing a change in sensed light corresponding to the touch location due to frustrated total internal reflection.

10. A system comprising, a display projector configured to display content for viewing through a compound curve surface, an infrared camera configured to sense infrared light and output frames of images corresponding to the sensed infrared light, and a touch detection algorithm configured to process at least some of the images to determine a point where the compound curve surface is contacted.

11. The system of claim 10 further comprising one or more infrared light sources.

12. The system of claim 11 wherein the one or more infrared light sources are positioned to illuminate a user's finger, and wherein the infrared camera is further configured to detect reflection off of the finger.

13. The system of claim 11 wherein the one or more infrared light sources are positioned to reflect infrared light towards the camera, and wherein the detection algorithm is configured to process images to detect one or more shadows corresponding to one or more points where the compound curve surface is contacted.

14. The system of claim 13 wherein the detection algorithm is configured to detect a shadow based upon luminance in one area relative to luminance in an adjacent area.

15. The system of claim 10 wherein the touch detection algorithm is further configured to transform the point where the compound curve surface is contacted into data representative of screen coordinates.

16. A method comprising, providing a curved surface with capacitive sensing, including combining capacitive sensing material with a diffusing substrate, and bonding the combined capacitive sensing material and diffusing substrate to a transparent interaction surface.

17. The method of claim 16 wherein combining the capacitive sensing material with the diffusing substrate comprises laminating flat, transparent touchscreen material to flat film, wherein bonding the combined capacitive sensing material and diffusing substrate to the transparent interaction surface comprises laminating the capacitive sensing material and diffusing substrate to the transparent interaction surface to provide a combined laminate, and forming the combined laminate into a three-dimensional shape.

18. The method of claim 16 wherein combining the capacitive sensing material with the diffusing substrate comprises laminating flat, transparent touchscreen material to flat film, and further comprising forming the combined capacitive sensing material and diffusing substrate into a three-dimensional shape for bonding to the transparent interaction surface.

19. The method of claim 16 wherein combining the capacitive sensing material with the diffusing substrate comprises laminating flat, transparent touchscreen material to flat film, and further comprising performing a molding process, including inserting the combined capacitive sensing material and diffusing substrate into an injection mold and injecting plastic into the injection mold to provide the transparent interaction surface that is bonded to the combined capacitive sensing material and diffusing substrate via the molding process.

20. The method of claim 16 wherein combining the capacitive sensing material with the diffusing substrate comprises laminating flat, transparent touchscreen material to flat film, and further comprising performing a film insert molding process that forms a three-dimensional shape as part of the molding process, including inserting the combined capacitive sensing material and diffusing substrate into an injection mold and injecting plastic into the injection mold to provide the transparent interaction surface that is bonded to the combined capacitive sensing material and diffusing substrate via the film insert molding process.
